(19) United States
(12) Patent Application Publication
(10) Pub. No.: US 2024/0286874 A1
(43) Pub. Date: Aug. 29, 2024

(54) CRANE FOR HATCH GUARD ACCESS

(71) Applicant: Safety Rail Company, LLC, Spring Park, MN (US)

(72) Inventor: Sam Linhoff, Crystal, MN (US)

(21) Appl. No.: 18/587,529

(22) Filed: Feb. 26, 2024

Related U.S. Application Data
(60) Provisional application No. 63/448,026, filed on Feb. 24, 2023.

(51) Int. Cl. B66C 23/20; B66C 23/74

(52) U.S. Cl. CPC B66C 23/203; B66C 23/205; B66C 23/74

(57) ABSTRACT

A portable crane for removable attachment to a safety rail system. The portable crane attaches to one or more guide rails on the safety rail system and is configured to raise and lower payloads without obstructing the roof hatch. The portable crane includes a planar ballast platform that lays flat on a roof, a winching mechanism affixed to a vertical post, and a boom extending at an angle from the vertical post. A pulley at an end of the boom permits the raising and lowering of a payload through the roof hatch. The ballast platform and vertical post may be removably attached to the guide rails with one or more U-bolts.

### RELATED APPLICATION

This application claims the benefit of U.S. Provisional Patent Application No. 63/448,026, filed Feb. 24, 2023, the disclosure of which is incorporated by reference herein in its entirety.

### FIELD OF THE DISCLOSURE

This disclosure is directed generally towards cranes and more specifically to a crane that can raise and lower payloads through a roof hatch.

### BACKGROUND OF THE DISCLOSURE

Roof hatches, such as those found in commercial buildings, provide generally quick and relatively easy access to a roof. Quick access is often required for performing maintenance and/or repairs to the roof structure itself, or other equipment commonly found on a commercial roof such as HVAC equipment or the like. Roof hatches are generally accessed via ladders, limiting the tools, supplies, materials, or the like that a user may need to what they are able to secure to their bodies while climbing. Further, the roof hatch opening itself may limit what can fit. For example, while a user might be able to climb a ladder with some lighter supplies in a backpack, a bulky sack might not fit through the hatch opening at the same time a user is climbing through the portal.

Large cranes capable of hoisting materials onto a roof can be very expensive to obtain and operate. Accordingly, large cranes may be cost prohibitive for routine items such as HVAC maintenance that requires only small amount of materials brought to a roof. Further, large cranes often require extensive planning to bring on site, making them unsuitable for use when quick or immediate roof access is required. In some instances, depending on topography, surrounding buildings/equipment, or the like, large cranes may not even be able to gain access to the roof. A crane that avoids the cost prohibitiveness of larger cranes as well as the payload limitations and access portal obstruction of conventional cranes would be welcomed.

### SUMMARY OF THE DISCLOSURE

A portable crane is disclosed that can be readily installed and deployed on a roof for raising or lowering payloads through a roof hatch. The crane is configured for removable attachment to a safety rail system that may surround the roof hatch. The portability of the crane enables ready installation adjacent any roof hatch, thus avoiding the need for modifications to the roof hatch structure or otherwise dedicating the crane to a certain roof hatch. In some embodiments, portable crane disclosed herein may be attachable to a portable safety rail system. Such a system is disclosed, for example, in U.S. Pat. No. 9,376,832, the contents of which are incorporated by reference herein in its entirety.

A crane that attaches to a ladder is disclosed at U.S. Patent Publication 2009/0095944 Gaines (“Gaines”). Smaller cranes that attach to the roof hatch or ladders may partially block access to the portal, thereby limiting the size of loads that can be hoisted to or from the roof. Such cranes may further be limited in the weight of payloads by way of the attachment points or the strength of intervening structures.

Structurally, the portable crane disclosed herein includes a planar ballast platform configured to lay on a roof. The ballast platform may receive a ballast weight. in some embodiments, the planar ballast platform includes a first guide rail attachment bracket that is generally orthogonal to the planar ballast platform. The first guide rail attachment bracket may be used for coupling to the lower side guide rail of the safety rail system. In some embodiments, the first guide rail bracket has a first end defining a first pair of bolt receiving apertures and a second end defining a second pair of bolt receiving apertures. Each of the pair of bolt receiving apertures may be configured to receive ends of a fastener assembly, for example a U-bolt. A first pair of the fastener assemblies may removably attach the first guide rail attachment bracket to the lower side guide rail.

In some embodiments, the crane includes a vertical post member extending upwardly from the planar ballast platform adjacent to the first guide rail attachment bracket. The vertical post member has a top portion opposite a bottom portion. The bottom portion is affixed to the planar ballast platform.

In some embodiments, the second guide rail attachment bracket has a generally L-shaped profile that includes a first leg for coupling to the upper side guide rail of the safety rail system. A second leg of the second guide rail attachment bracket may include an aperture through which the vertical post member can pass. In some embodiments, the first leg has a first end defining a first pair of bolt receiving apertures and a second end defining a second pair of bolt receiving apertures. Each of the pair bolt receiving apertures may be configured to receive ends of a fastener assembly, such as a U-bolt. A second pair of fastener assemblies may removably attach the second guide rail attachment bracket to the upper side guide rail.

In some embodiments, the crane includes an upper arm member having a first end affixed to the top portion of the vertical post member at an angular attachment portion and a second end for extending over the roof access hatch. An obtuse angle may be defined between the upper arm member and vertical post member. In some embodiments, a hook pulley is attached to the second end of the upper arm member. A guide pulley may be affixed to the angular portion.

The crane may include a winching mechanism having a spool and a handle, and a crane cable. A first end of the crane cable may be wound about the spool and a crane hook may be affixed to a second end of the crane cable. In some embodiments, the crane cable is configured to extend around the guide pulley and the hook pulley. The winching mechanism may be configured to raise the crane hook when the handle is rotated in a first direction and to lower the crane hook when the handle is rotated in a second direction, the second direction being opposite of the first direction.

### BRIEF DESCRIPTION OF THE DRAWINGS

FIG. 1 is a perspective view of a portable crane attached to a hatch guard surrounding a roof hatch according to an embodiment of the disclosure;

FIG. 2A is a perspective top view of a portable crane according to an embodiment of the disclosure;

FIG. 2B is a perspective bottom view of the portable crane of FIG. 2A according to an embodiment of the disclosure;

FIG. 3A is a left side view of the portable crane of FIG. 2A according to an embodiment of the disclosure;

FIG. 3B is a right side view of the portable crane of FIG. 2A according to an embodiment of the disclosure;

FIG. 3C is a top view of the portable crane of FIG. 2A according to an embodiment of the disclosure;

FIG. 3D is a bottom view of the portable crane of FIG. 2A according to an embodiment of the disclosure; and

FIG. 4 is an exploded view of the portable crane of FIG. 2A according to an embodiment of the disclosure.

While the embodiments of the disclosure are amenable to various modifications and alternative forms, specifics thereof have been shown by way of example in the drawings and will be described in detail. It should be understood, however, that the intention is not to limit the disclosure to the particular embodiments described. On the contrary, the intention is to cover all modifications, equivalents, and alternatives falling within the spirit and scope of the disclosure.

### DETAILED DESCRIPTION OF THE FIGURES

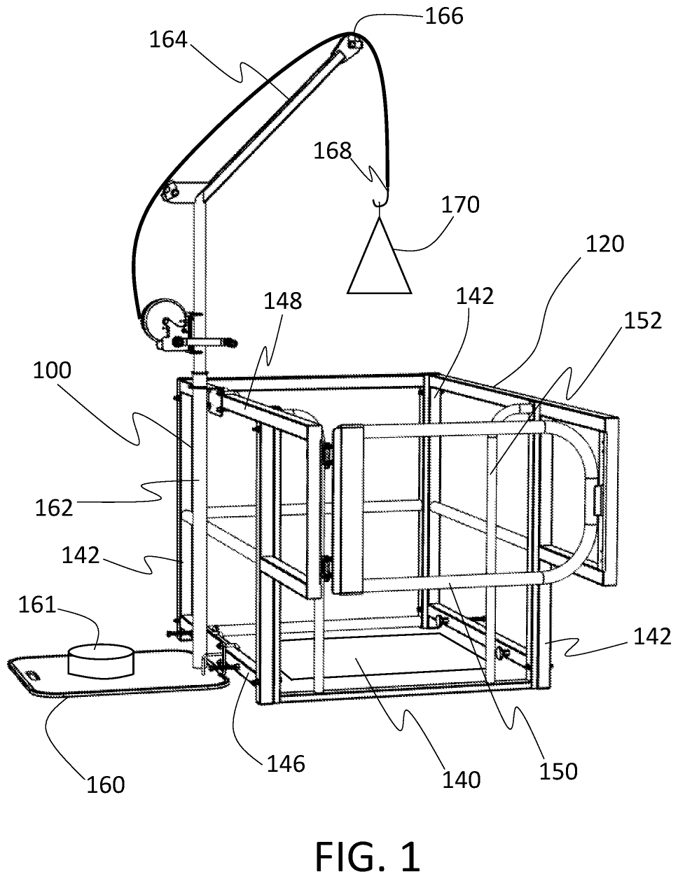

Referring to FIG. 1, a portable crane 100 affixed to a hatch guard 120 is depicted according to an embodiment of the disclosure. The hatch guard 120 surrounds a roof hatch 140. As shown, the hatch guard 120 is a safety rail system including four corner post members 142 extending upwardly from a roof and a plurality of lateral guide rails 144 extending between corner post members 142, forming a protective perimeter surrounding the roof hatch 140. The guide rails 144 may include a lower side guide rail 146 and an upper side guide rail 148. Additional side guide rails may be interposed between the lower and upper side guide rails 146, 148. The safety rail system defines an interior that is generally free of obstruction and contains only the roof access hatch 140. One side of the hatch guard 120 may include a gate 150 and one or more handrails 152 to facilitate users gaining access to the roof hatch 140 and entrance or egress to or from the interior of the building through the roof hatch 140.

The portable crane 100 may be generally positioned such that the crane 100 is outside the perimeter of the hatch guard 120. The portable crane 100 may include a planar ballast platform 160 positioned on the roof outside of the hatch guard 120. In some embodiments, the ballast platform 160 may be attached to a guide rail, such as lower guide rail 146. In some embodiments, the crane 100 has a vertical post member 162 that may be attached to a guide rail, such as upper guide rail 148. More detail regarding attachment of the portable crane to the safety rail system is provided below.

The portable crane 100 may include an upper arm member 164 that extends over roof hatch 140. The upper arm member 164 may include a hook pulley 166 configured for raising or lowering a hook 168 attached to a payload 170 through the roof hatch 140. In such a configuration, the crane 100 does not impede access to the roof hatch 140. Accordingly, when the crane 100 is not in use, operators may easily enter or exit the roof hatch 140 without having to maneuver about the crane 100 or its components. When the crane 100 is in use, the lack of crane components obstructing the roof hatch 140 permits larger payloads 170 to be raised or lowered through the roof hatch 140.

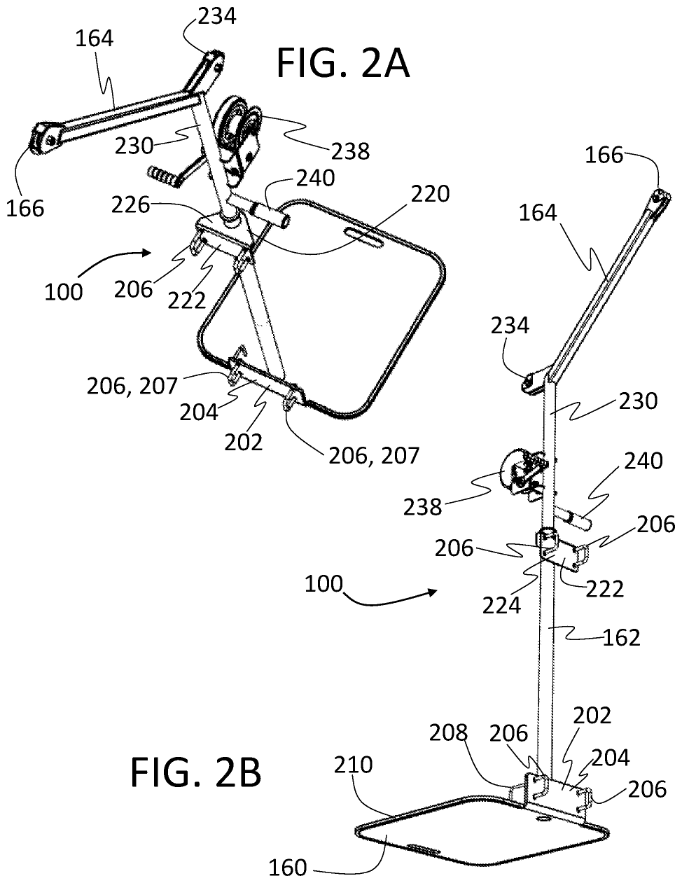

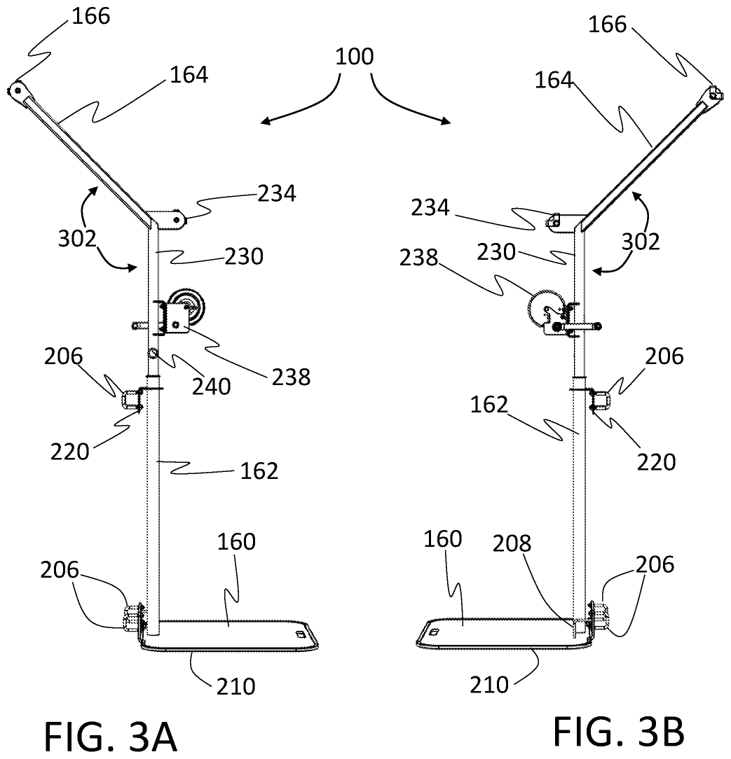

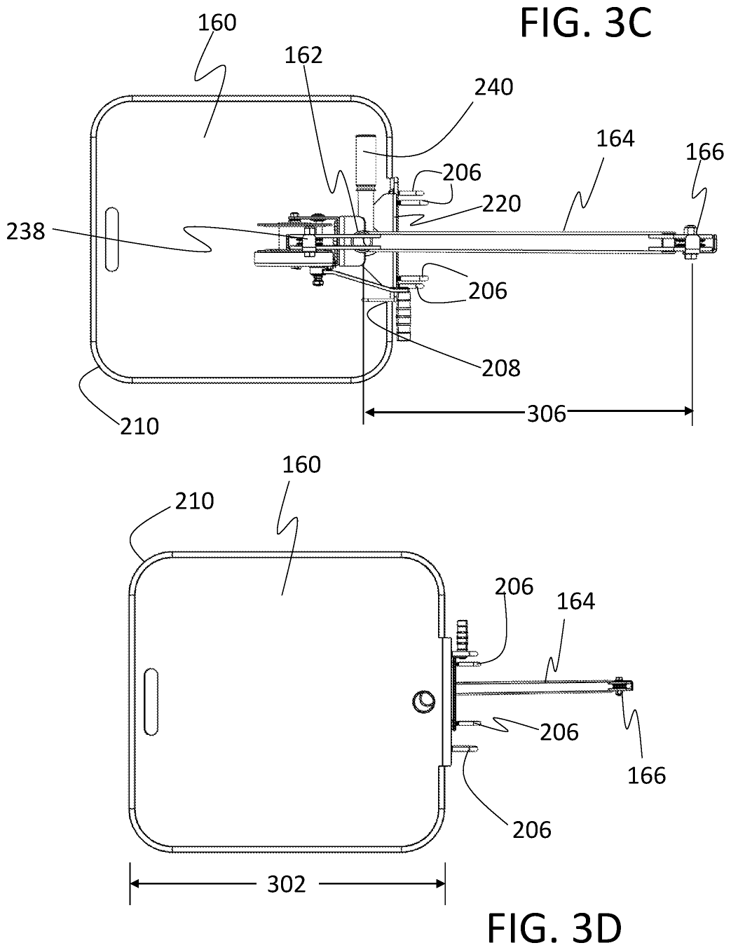

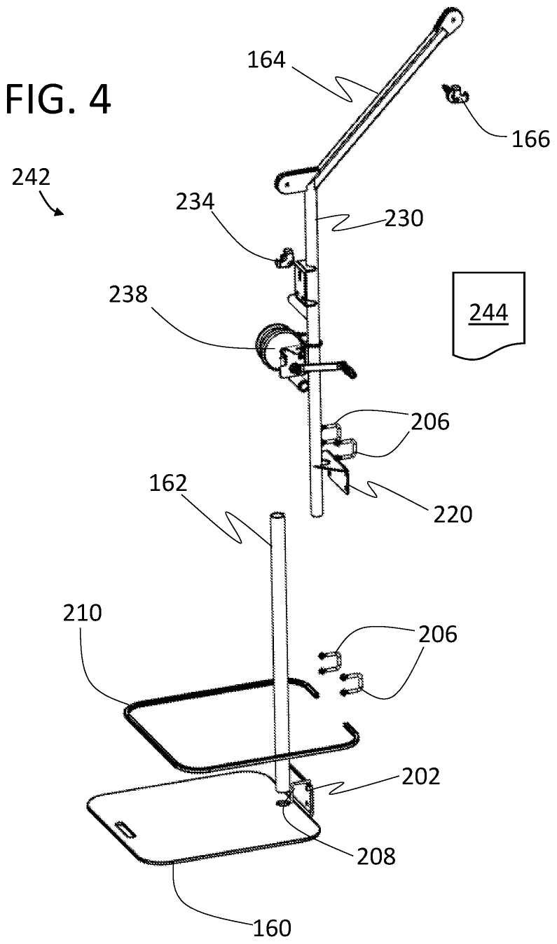

Referring to FIGS. 2 and 3, various views of the portable crane 100 are depicted in isolation according to an embodiment of the disclosure. FIG. 4 depicts an exploded view of the portable crane 100, as shown in FIGS. 2 and 3, and described in detail below.

The portable crane 100 includes a planar ballast platform 160 configured to lay generally flat on a roof. The ballast platform 160 includes a guide rail attachment bracket 202. The guide rail attachment bracket 202 is generally orthogonal to the ballast platform 160 and has an outward facing surface 204 configured to abut a guide rail, such as the guide rail 144 of a safety rail system. In some embodiments, the guide rail attachment bracket 202 may be integral with the ballast platform 160. In some embodiments, the guide rail attachment bracket 202 may be affixed to the ballast platform 160. For example, the guide rail attachment bracket 202 may be permanently affixed to the ballast platform 160 by welding or the like. In some embodiments, the guide rail attachment bracket 202 may be removably affixed to the ballast platform 160 through screws, bolts, or the like. In some embodiments, the guide rail attachment bracket 202 may include a plurality of through holes for receiving one or more fastener assemblies 206. In some embodiments, the fastener assemblies may include a U-bolt 207 positioned to clamp the guide rail attachment bracket 202 to a rail 144 on a hatch guard 120. In some embodiments, a hook attachment 208 may extend between the guide rail bracket 202 and the ballast platform 160. When the crane 100 is not in use, the hook 168 can be secured to the hook attachment 208 and the winch tightened, thereby mitigating a free-swinging hook 168 as a hazard to any crew working on the roof or moving about the hatch. The ballast platform 160 may further include a protective layer, such as rubber gasket 210, surrounding an outside edge of the platform 160. The protective layer can prevent the ballast platform 160 from damaging a roof when in use. In some embodiments, a protective layer may be affixed to a downward facing surface of the ballast platform 160.

The vertical post member 162 extends upwardly from the ballast platform 160. The vertical post member 162 is generally positioned near a forward edge portion of the ballast platform 160. The vertical post member may be behind and generally centered upon the guide rail attachment bracket 202. In some embodiments, the vertical post member 162 may be removably affixed to the ballast platform 160 through screws, bolts, or the like. In some embodiments, the vertical post member 162 may be permanently affixed to the ballast platform 160 by welding or the like. In some embodiments, the vertical post member 162 is tubular.

The post member attachment bracket 220 may be used to removably attach the vertical post member 162 to a rail 144 of the safety rail system. The post member attachment bracket 220 may have a first leg 222 including an outwardly facing planar surface 224 configured to generally abut a rail 144. The first leg 222 may include a plurality of through holes configured to receive one or more fastener assemblies 206. The fastener assemblies 206 may surround a rail 144 of the hatch guard 120 to secure the post member attachment bracket 220. In some embodiments, the post member attachment bracket 220 may be removably attached to the vertical post member 162 through clamps, screws, bolts, or the like. In some embodiments, the post member attachment bracket 220 may be permanently attached to the vertical post member 162 through welding or the like. In some embodiments, the post member attachment bracket 220 may be generally “L” shaped with a second leg 226 orthogonal to first leg 222 and configured for attachment to the vertical post member 162. In some embodiments, the second leg 226 includes a through hole configured to receive the vertical post member 162. The through hole may be generally sized to the outer diameter of the vertical post member 162 permitting the post member attachment bracket 220 to slide up and down along the vertical post member 162. Accordingly, the post member bracket 220 may be readily adjusted to the proper height of a corresponding rail on the safety rail system for attachment. In some embodiments, the second leg 226 may taper inwardly from the first leg 222 towards the vertical post member 162, providing additional space and maneuverability for a crane operator.

The upper arm member 164 may include a first tubular leg 230 and a boom portion 232. The tubular leg portion 230 is configured to fit within the vertical post member 162 and extend upwardly beyond a top portion of the vertical post member. The boom portion 232 extends upwardly at an angle 302 from a top portion of the first tubular leg 230. In some embodiments, the angle 302 is an obtuse angle. In some embodiments, the angle 302 is between 90 and 180 degrees. In some embodiments, the first tubular leg 230 may be removably attached to the boom portion 232 using screws, bolts, or the like. In some embodiments, the first tubular leg 230 may be permanently attached to the boom portion 232 through welding or the like. The guide pulley 234 may be affixed to the upper arm member 164 where the first tubular leg 230 and the boom portion 232 intersect. The hook pulley 166 may be affixed to a distal end of the boom portion 232.

The tubular leg 230 may further include a winch mechanism 238 and a handle 240. The winch mechanism 238 may be permanently attached to the tubular leg 230 by welding or the like, or removably attached with clamps, screws, bolts, or the like. The handle 240 provides a grip for comfortable operation of the winch. In some embodiments, pulling or pushing on the handle 240 rotates the tubular leg 230 within the vertical post member 162. Accordingly, a payload 170 may be swung to or from the rooftop area and over the hatch 140. A cable 172, as shown in FIG. 1, extends from the winch mechanism 238, about the guide pulley 234 and the hook pulley 166, and terminates at the hook 168. The cable 172 may be any suitable cable with a sufficient tensile strength for hoisting a particular payload. The cable 172 may be rope, metal, or any known combinations thereof.

As shown, the winch mechanism 238 and the guide pulley 234 are generally situated above the ballast platform 160, and the boom 232, hook pulley 166, and payload 170 extend away from the ballast platform 160. Accordingly, any weight on the ballast platform 160 serves as a counterbalance to the payload 170. In some embodiments, a user may act as a counterbalance. In some embodiments, additional ballasts or counterweights 163 may be placed on ballast platform 160 as necessary to counter the weight of a payload 170. One skilled in the art will further appreciate that a crane 100 with a payload 170 would be inclined to tip towards the roof hatch 140, or more particularly towards the roof hatch guard 120. Accordingly, once the portable crane 100 is affixed to the guide rails 144 of a roof hatch guard 120, the entire roof hatch guard 120 acts as additional support for the portable crane 100.

The ballast platform 160 may have a length 302 of between 24 and 36 inches. In some embodiments, a length 302 of the ballast platform 160 is about 30 inches. The ballast platform 160 may have a width 304 of between 24 and 36 inches. In some embodiments, the ballast platform 160 has a width 304 of about 28 inches. In some embodiments, the ballast platform 160 has a width and a length that are similar. In some embodiments, the ballast platform 160 has a length that is longer than a width. The guide rail attachment bracket 202 may have a width between 6 and 18 inches. In some embodiments, the guide rail attachment bracket 202 has a width of about 12 inches. In some embodiments, the guide rail attachment bracket 202 is wider than the post member attachment bracket 220. The hook pulley 166 may have a height of between 80 and 115 inches above the roof. In some embodiments, the hook pully 166 is about 95 inches above the roof. In some embodiments, the hook pulley 166 is about 52 inches above the top most guide rail. In some embodiments, the winch mechanism 238 is about 50 inches above the roof. As depicted in the top view in FIG. 3C, the hook pulley 166 has an outward projection 306 from the vertical post member 162 of between 12 and 50 inches. In some embodiments, the outward projection 306 is about 24 inches.

The crane 100 may be brought to a rooftop disassembled for easier transport and assembled on site. The post member attachment bracket 220 may be slid onto the vertical post member 162. The vertical post member 162 may be attached to the ballast platform 160, and then the ballast platform 160 may be positioned so that the forward facing surface 204 of the guide rail attachment bracket 202 generally abuts a lower guard rail 146. The post member attachment bracket 220 may be adjusted so that it generally abuts an upper guide rail 148. Once the brackets 202,220 are in position, one or more U-bolts 207 may be used to secure the brackets 202,220 to the guide rails 144,146, thereby securing the ballast platform 160 and vertical post member 162 in place and adding structural stability to the crane 100. For example, the safety rail system may prevent the crane from tipping under load. A bottom portion of the first tubular leg 230 may be inserted into an opening in the top of the vertical post member 162, and then the first tubular leg 239 may be slid within the vertical post member 162 such that the first tubular leg 230 and vertical post member 162 are coaxial, and the first tubular leg 239 may rotate about the shared axis. In some embodiments the first tubular leg 239 includes a winching mechanism 238 for operating the crane 100. In some embodiments, a winching mechanism 238 may be affixed to the first tubular leg 239. A cable 172 may be fed from the winching mechanism 238, about the guide pulley 234, and then about the hook pulley 166. A hook 168 or other attachments may be secured to an end of the cable 172 for attachment to a payload 170. A crane operator standing on the ballast platform 160 can readily operate the winch mechanism 238 with one hand, while the operator's other hand can use a handle 240 to rotate the first tubular leg 239 and, by extension, the boom portion 232, hook pulley 166, and any payload 170 attached thereto. For example, an operator could raise a payload 170 from below up toward the hook pulley 166 until it clears the safety rail 120, rotate the boom 232 so that the payload 170 is generally over the roof or ballast platform 160, and then lower the payload 170. Similarly, an operator could attach a payload 170 on the roof to the crane 100, raise it until it clears the guide rails 144, swing the load 170 over the roof hatch 140, and lower it to within the building. In some uses, an operator standing on the ballast platform 160 may act as a ballast 161 to counterbalance a payload 170. If an operator is of insufficient weight, or intends to move about the crane, additional ballasts 161 may be placed on the ballast platform 160. When the crane 100 is not in use, a hook 168 or attachment device at the end of the cable 172 may be secured to a hook attachment 208 mounted between the ballast platform 160 and the guide rail attachment bracket 202. For example, the hook 168 could be secured to the hook attachment 208 and then the winching mechanism 238 used to remove slack from the cable 172 and keep the hook 168 in place. In such a position, the hook 168 and cable 172 are maintained out of the way of any operators or other personnel around the crane 100, thereby reducing the risk of them becoming a tripping or other hazard. The crane may be readily disassembled for removal by generally reversing the steps used to erect and the mount the crane to the safety rail system.

In some embodiments, some or all of the components of the disclosed systems and devices are provided as a kit 242 (depicted at FIG. 4), complete with instructions 244 for use. The instructions 244 are provided on a tangible, non-transitory medium, and may be physically included with the kit 242 such as on a printed document (depicted), compact disc, or flash drive. Non-limiting examples of a tangible, non-transitory medium include a paper document and computer-readable media including compact disc and magnetic storage devices (e.g., hard disk, flash drive, cartridge, floppy drive). The computer-readable media may be local or accessible over the internet. The instructions 244 may be complete on a single medium, or divided among two or more media. For example, some of the instructions 244 may be written on a paper document that instruct the user to access one or more of the steps of the method over the internet, the internet-accessible steps being stored on a computer-readable medium or media. The instructions 244 may embody the techniques and methods depicted or described herein using text, photos, videos, or a combination thereof to instruct and guide the user. The instructions may be in the form of written words, figures, photos, video presentations, or a combination thereof to instruct and guide the user.

The embodiments above are intended to be illustrative and not limiting. In addition, although the present invention has been described with reference to particular embodiments, those skilled in the art will recognize that changes can be made in form and detail without departing from the spirit and scope of the invention. Any incorporation by reference of documents above is limited such that no subject matter is incorporated that is contrary to the explicit disclosure herein. To the extent that specific structures, compositions and/or processes are described herein with components, elements, ingredients or other partitions, it is to be understood that the disclosure herein covers the specific embodiments, embodiments comprising the specific components, elements, ingredients, other partitions or combinations thereof as well as embodiments consisting essentially of such specific components, ingredients or other partitions or combinations thereof that can include additional features that do not change the fundamental nature of the subject matter, as suggested in the discussion, unless otherwise specifically indicated.

Unless indicated otherwise, references to “embodiment(s)”, “disclosure”, “present disclosure”, “embodiment(s) of the disclosure”, “disclosed embodiment(s)”, and the like contained herein refer to the specification (text, including the claims, and figures) of this patent application that are not admitted prior art.

For purposes of interpreting the claims, it is expressly intended that the provisions of 35 U.S.C. 112(f) are not to be invoked unless the specific terms “means for” or “step for” are recited in the respective claim.

What is claimed is:

1. A portable crane for removable attachment to a safety rail system, the portable crane comprising:
a planar ballast platform configured to lay on a roof, the planar ballast platform comprising a first guide rail attachment bracket for coupling to a lower side guide rail of the safety rail system;
a first pair of U-bolts for removably attaching the first guide rail attachment bracket to the lower side guide rail;
a vertical post member extending upwardly from the planar ballast platform adjacent to the first guide rail attachment bracket, the vertical post member including a top portion opposite a bottom portion, wherein the bottom portion is affixed to the planar ballast platform;
a second guide rail attachment bracket defining a generally L-shaped profile including a first leg for coupling to an upper side guide rail of the safety rail system and a second leg defining an aperture through which the vertical post member passes;
a second pair of U-bolts for removably attaching the second guide rail attachment bracket to the upper side guide rail;
an upper arm member having a first end affixed to the top portion of the vertical post member at an angular attachment portion and a second end for extending over a roof access hatch to define an obtuse angle between the upper arm member and vertical post member
a hook pulley attached to the second end of the upper arm member;
a guide pulley affixed to the angular portion;
a winching mechanism comprising a spool and a handle; and
a crane cable.

2. The portable crane of claim 1, wherein a first end of the crane cable is wound about the spool and a crane hook is affixed to a second end of the crane cable, the crane cable extending around the guide pulley and the hook pulley.

3. The portable crane of claim 1, wherein the winching mechanism is configured to raise a crane hook when the handle is rotated in a first direction and to lower the crane hook when the handle is rotated in a second direction, the second direction being opposite of the first direction.

4. The portable crane of claim 1, wherein the first guide rail bracket comprises a first end that defines a first pair of bolt receiving apertures and a second end defining a second pair of bolt receiving apertures, each of the pair bolt receiving apertures configured to receive ends of a U-bolt.

5. The portable crane of claim 1, wherein the first leg of the second guide rail attachment bracket comprises a first end defining a first pair of bolt receiving apertures and a second end defining a second pair of bolt receiving apertures, each of the pair bolt receiving apertures configured to receive ends of a U-bolt.

6. The portable crane of claim 1, wherein the first guide rail attachment bracket that is generally orthogonal to the planar ballast platform.

7. The portable crane of claim 1, wherein the planar ballast platform is configured to receive a ballast weight.

8. The portable crane of claim 1, wherein the planar ballast platform comprises a rubber gasket.

9. The portable crane of claim 1, where in a hook attachment extends between the ballast platform and the first guide rail attachment bracket.

10. A method of using a portable crane comprising:
providing a portable crane in a disassembled configuration;
transporting the portable crane to a rooftop;
assembling the portable crane; and
securing the portable crane to a safety rail system surrounding a roof hatch,
wherein the portable crane comprises a planar ballast platform, a vertical post member, an upper arm member, a winching mechanism, a crane cable, a guide pulley, a hook pulley, and a hook.

11. The method of claim 10, wherein the step of assembling the portable crane comprises:
affixing the vertical post member to the planar ballast platform;
affixing the upper arm member to the vertical post member;
feeding the crane cable from the winching mechanism, around the guide pulley, to the hook pully; and
affixing a hook to an end of the cable.

12. The method of claim 10, wherein the safety rail system comprises a lower side guide rail and an upper side guide rail;
the portable crane comprises a first guide rail attachment bracket and a second guide rail attachment bracket; and
the step of affixing the portable crane to the safety rail system comprises:
securing the first guide rail attachment bracket to the lower side guide rail with a first pair of U-bolts; and
securing the second rail attachment bracket to the upper side guide rail with a second pair of U-bolts.

13. The method of claim 10, wherein the portable crane comprises instructions for use on a tangible, non-transitory medium.

14. The method of claim 13, wherein the instructions for use include the steps of assembling the portable crane and securing the portable crane to the safety rail system.

15. A rooftop crane for raising and lowering contents through a hatch comprising:
a planar platform, a vertical post extending upwardly therefrom, at least two attachment brackets configured to secure the vertical post to a railing system, and a boom projecting out from a top portion of the vertical post, the boom having a distal end positionable above the hatch, wherein no part of the rooftop crane constricts access to the hatch.

16. The rooftop crane of claim 15, wherein the vertical post comprises a handle configured to rotate the post about a central, the rotation of which controls a position of the distal end of the boom.

17. The rooftop crane of claim 15, wherein the distal end of the boom is between 80 and 115 inches above the hatch.

18. The rooftop crane of claim 15, wherein a winching mechanism is affixed to the vertical post.

19. The rooftop crane of claim 18, wherein a cable extends from the winching mechanism to the distal end of the boom.

20. The rooftop crane of claim 18, wherein the winching mechanism is configured to raise or lower a payload through the hatch.
